(19) United States
(12) Patent Application Publication
(10) Pub. No.: US 2007/0112733 A1
(43) Pub. Date: May 17, 2007

(54) Method and system for extracting customer attributes

(76) Inventors: Dirk M. Beyer, Walnut Creek, CA (US); Troy A. Shahoumian, Sunnyvale, CA (US); Alex X. Zhang, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/272,907

(22) Filed: Nov. 14, 2005

(51) Int. Cl. G06F 17/30

(52) U.S. Cl. 707/3

(57) ABSTRACT

A method for extracting customer attributes from a database includes providing information regarding one or more content, one or more metrics, customer ID and a reference date and extracting customer attributes based on the information.

### BACKGROUND

Understanding customer behavior is helpful in order to be able to understand what makes a potential customer decide to purchase or not purchase a particular product or service. Knowing what influences a customer's purchase decisions helps a business efficiently target potential customers.

### BRIEF DESCRIPTION OF THE DRAWINGS

For a detailed description of exemplary embodiments of the invention, reference will now be made to the accompanying drawings in which:

FIG. 1 shows a diagram of a computer system in accordance with an embodiment of the invention;

FIG. 2 highlights different customer attributes in accordance with an embodiment of the invention;

FIG. 3 shows a graphical user interface (GUI) that can be used for attribute extraction in accordance with an embodiment of the invention;

FIG. 4 shows a flowchart of an attribute extraction technique in accordance with an embodiment of the invention; and

FIG. 5 shows a flowchart of a labeled dataset extraction in accordance with an embodiment of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising”are used in an open-ended fashion, and thus should be interpreted to mean “including, but not limited to . . . ” Also, the term “couple” or “couples” is intended to mean either an indirect or direct electrical, wireless, optical or other type of connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and is limited to that embodiment.

Embodiments of the present invention relate to automatically extracting attributes of customers from historical transaction records and associating labels with the extracted attributes to form a labeled dataset. Transaction records describe an event, characterized by a time stamp, an actor (e.g., customer), metrics of the event (e.g., revenue generated) and possibly other descriptions of the event (e.g., sales channel used). Customer attributes on the other hand describe the sate of a customer at a certain point in time. At least part of this state is, or is a summary of, the history of experiences of the customer. Some of those experiences are the transactions with which the customer was involved. To make the description of the state of the customer tractable for predictive analysis, these experiences are aggregated in a systematic fashion. The labeled dataset can then be used to construct a customer response model. The customer response model can be used to design an efficient advertising campaign to match advertising content and recipients. The advertisements may comprise direct mail advertising, telephone solicitations, web advertising, etc. The subject matter described herein relates to the process of customer attribute extraction.

While terminology from a marketing viewpoint is used herein, the methodology is applicable to any form of transactional data in which time-stamped measurements as a response to a stimulus are recorded.

An embodiment of the present invention transforms and aggregates customer related data into a format suitable for use by a data mining application. In one embodiment, the format comprises a table in which each row corresponds to an event (e.g., an offer to sell a product to a customer). The columns of the table can be divided into two sections. A first section comprises customer attributes that relate to the state of mind of a customer at the time of the event. A second section comprises response metrics describing the response of the customer to the event. Examples of such metrics comprise an indicator variable indicating whether the customer responded, the revenue of the transaction, the stated satisfaction of the customer with the product, etc.

A customer behavior model is constructed using a training dataset. Embodiments of the present invention relate to the formation of the training dataset. The model can be used to predict response metrics as a function of the attributes of a customer. Attributes derived from past transactions (e.g., offers and purchases) generally are useful to predict future customer behavior. These “transaction-based” attributes are dynamic and determined with respect to the date of the relevant event.

Embodiments of the present invention include one or more of at least the following features or actions:
Describing criterion for the selection of events used for creating a training dataset;
Describing response metrics to be extracted from a database;
Describing attributes to be extracted; and
Automating the process of data transformation from the format in which data is stored in a business' transaction database system into a format suitable for model calibration based on the three descriptive user inputs listed above.

In one embodiment, the events to be used to extract are described by providing a set of identifiers (IDs) of the content that was presented for the event of interest, a time interval for the events of interest, and a set of IDs of customers of interest, or any other way of specifying a customer list.

In some embodiments of the invention, the response metrics to be extracted for each event are described by any or all of the following:
The name of a metric stored in the transaction database or being derivable from the metrics stored (e.g., revenue of transaction, whether the customer respond (a derived value));
An aggregation function (e.g., sum, average, min); and
A threshold to transform any numerical metric into an indicator (e.g., more than $10 [yes/no]?).

In some embodiments, the attributes to be extracted are described by any or all of the following:
A set of content IDs or a set of product IDs consistent with those stored in the transaction records on which the attribute is based (content ID are used for attributes about offers, product IDs are used for attributes about purchases);
A time interval over which to aggregate (e.g., time expressed relative to the event as in, for example, three months preceding event);
The name of the metric stored in the transaction database or being derivable from the stored metrics (e.g., revenue of transaction, whether the customer responded (a derived value), whether the customer receive the offer (a derived value));
An aggregation function (e.g., sum, average, min); and
A threshold value to transform any numerical metric into an indicator (“larger than $10 [yes/no]?”) or any other function transforming the aggregated metric (e.g., an indicator whether the value is in a given interval to transform a continuous variable into a categorical one or min (x, CAP) to replace any value greater than CAP with CAP to remove outliers).

A graphical user interface (GUI) can be used to enter or select the values that are then used to extract customer attributes from a database. The extracted attributes can then be used as a training data set for generating the customer behavior model noted above. The ease of entry of the relevant information allows for almost any user to conduct a customer attribute extraction without the need to rely on skilled database operators. In other embodiments, non-graphical interfaces or automatic systems that do not use an interface can also be used.

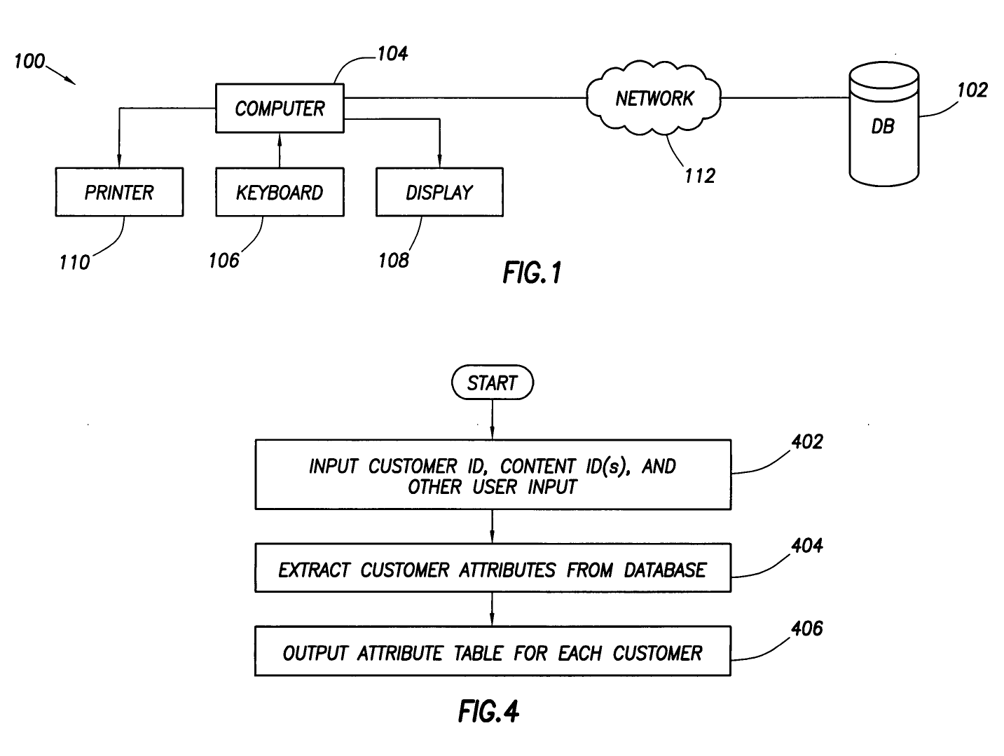

Customer attributes comprise characteristics of a customer generally deemed relevant to the state of mind of a customer at a given time or period of time. In accordance with embodiments of the invention, such characteristics comprise customers' demographics such as any one or more of age, income, or marital status, as well as records of previous transactions and experiences. To use records of previous transactions and experiences to predict future behavior, transaction records of those experiences (e.g., records of previous purchases or records of inclusion of a customer into earlier advertising campaigns) are aggregated in a suitable fashion. An aggregation method aggregates transactional data from a database to create customer attributes in a way that is compatible with now known or later developed procedures for learning and applying customer response models. The transactional data which can be stored in a database (see FIG. 1, item 102) help describe event(s) such as the purchase of a product and/or service, the mailing of an advertisement and other events that may have occurred in the marketplace. In at least one embodiment, customer attribute extraction and labeling of the dataset is performed automatically. This process helps marketers or vendors to predict the reaction of customers to, for example, a new product advertisement.

Referring to FIG. 1, in accordance with an embodiment of the invention, system 100 includes a database 102 and a computer 104 that can access and manipulate the information stored in the database 102. The computer 104 is coupled to the database via a network 112 such as the Internet or a local area network (LAN). The computer 104 can include or be coupled to a keyboard 106, display 108 and printer 110. One or more or all of the actions described herein are performed by software running on the computer of the system 100 pursuant to user interaction.

In accordance with an embodiment of the invention, database 102 includes information on past customers such as a customer list and past purchases of such customers. Linked to specific customer identification information or records stored in database 102 is additional information regarding customer demographic and/or psychographic information. Other information stored in database 102 may include a list of marketing stimuli, which is also referred to as “content” or “marketing content,” that has been used in the past (or may be used in the future) for a particular customer. Stimuli might include, for example, past marketing campaigns directed to the customer (e.g., a discount coupon sent to customer for a printer, etc.). Products such as printers and digital cameras associated with the particular stimuli are also linked to the stimuli and stored in database 102. Further, any responses from customers to such stimuli are also stored in the database. Illustrative examples of customer responses include a customer replying to an on-line survey, a customer requesting product information, or a purchase.

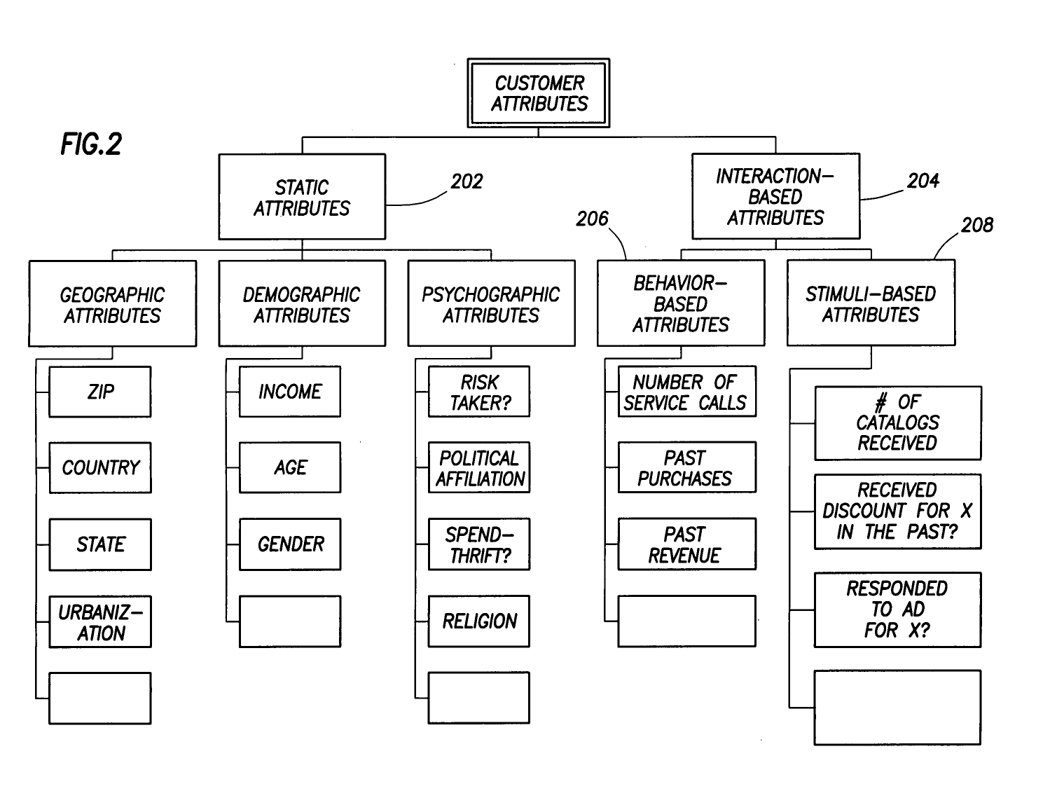

Numerous customer attributes can be used in database 102. FIG. 2 shows an exemplary attribute tree that includes two classifications of attributes, static attributes 202 and interaction-based attributes 204 (also referred to as “transaction-based attributes”). The static attributes 202 comprise attributes that are independent of any customer transactions with which the customer may have been involved. Examples of static attributes include, as shown, customer address information, age of customer and political affiliation.

Interaction-based attributes 204 are subcategorized further as behavior-based attributes 206 and stimuli-based attributes 208. Behavior-based attributes 206 include information regarding past customer actions. Illustrative examples include past purchases made by the customer and past revenue earned by selling products to the particular customer. The stimuli-based attribute category 208 includes attributes that are based on stimuli that have been applied to a customer before the event under consideration and the reactions that resulted from the stimuli. For example, a customer may have received an offer to buy a color printer and the customer spent $1,000 on the printer. The customer's purchase of the printer and the amount spent represent stimuli-based attributes.

Interaction-based attributes 204 can be characterized by one of three “dimensions” that include a time interval corresponding to the attribute, a metric of interest (e.g., total revenue received from a particular customer, average sales) or a selection criteria which is used to determine the events that are to be summarized by the attribute. The number, types or grouping of attributes, can be different from that described herein as desired. The attribute tree highlighted in FIG. 2 is an illustrative example of how attributes can be classified in accordance with an embodiment of the invention.

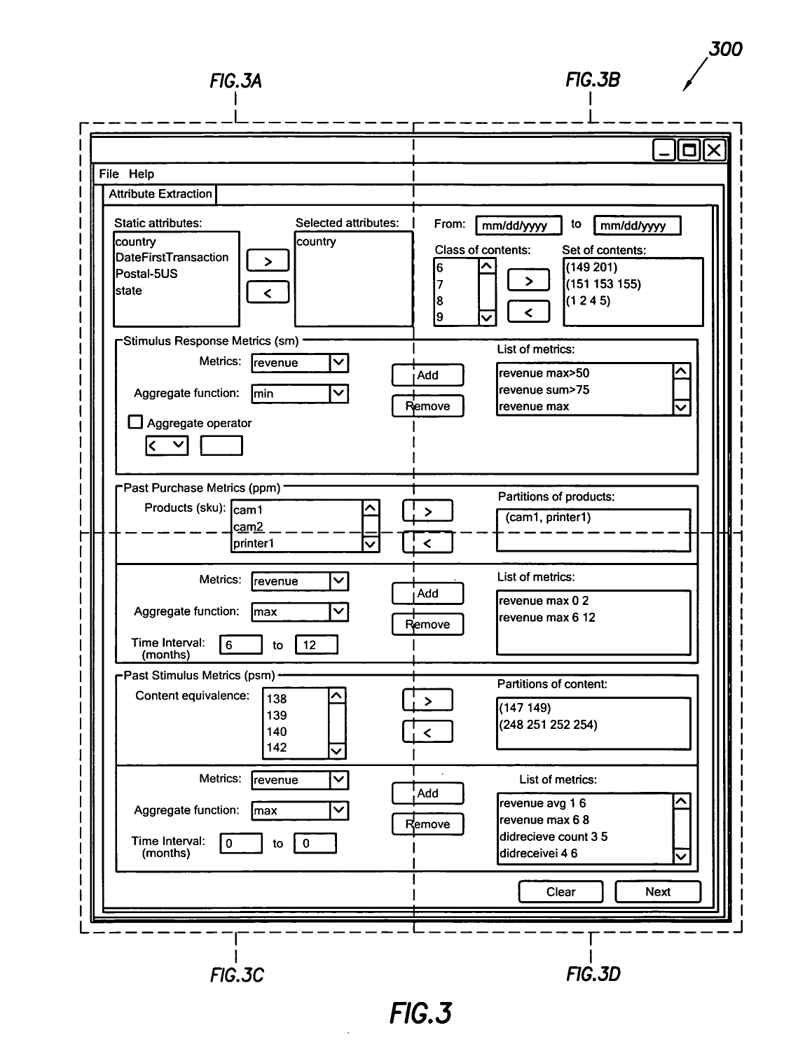

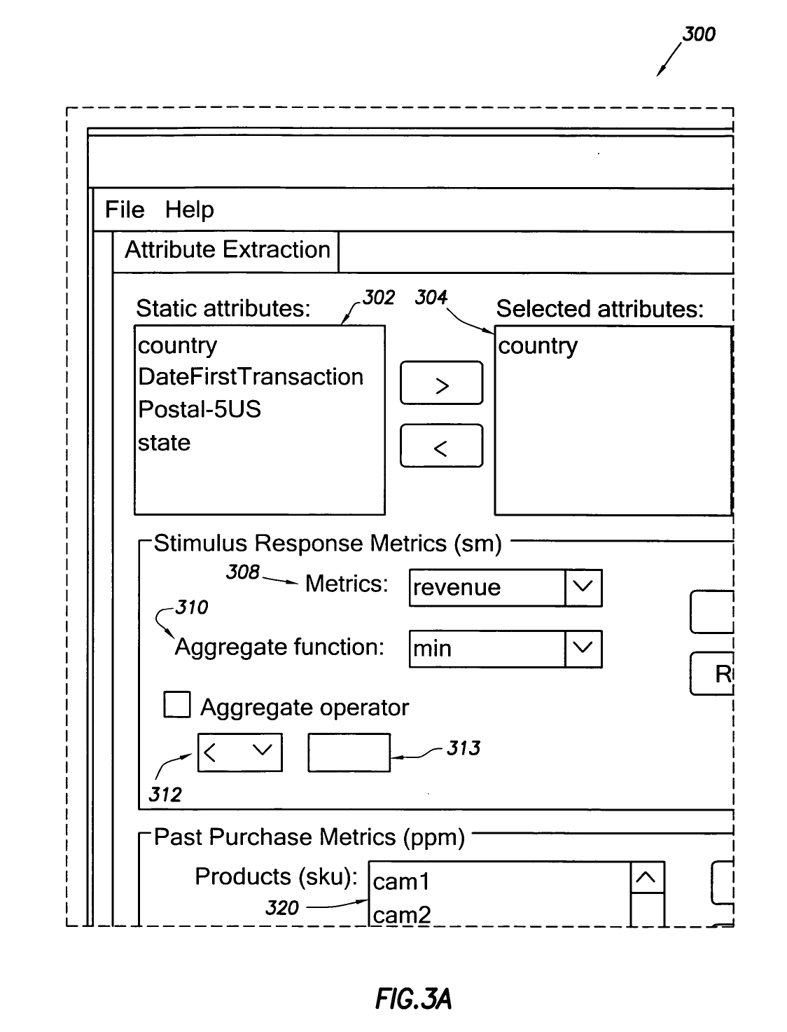

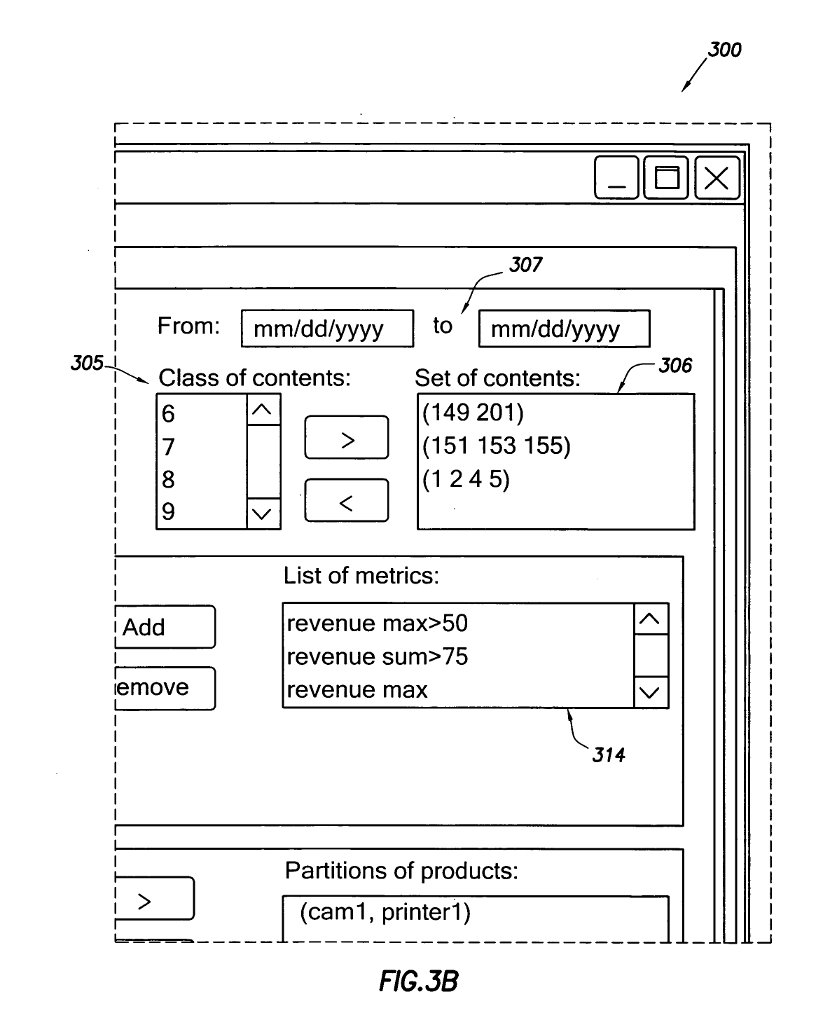

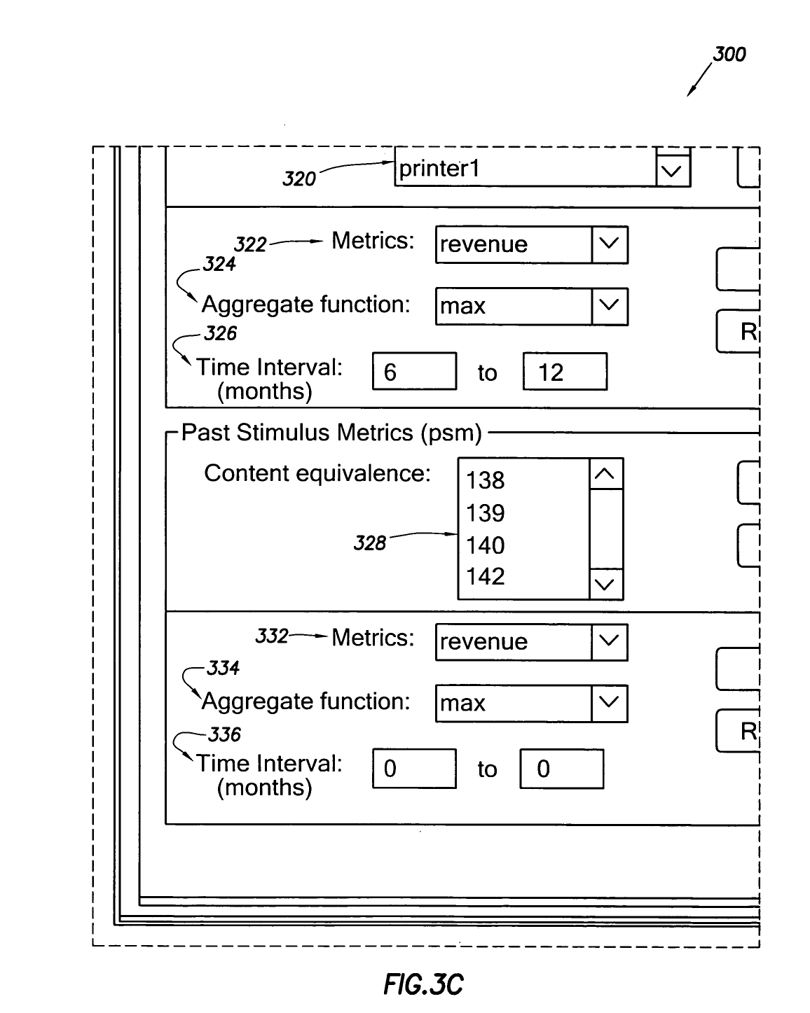

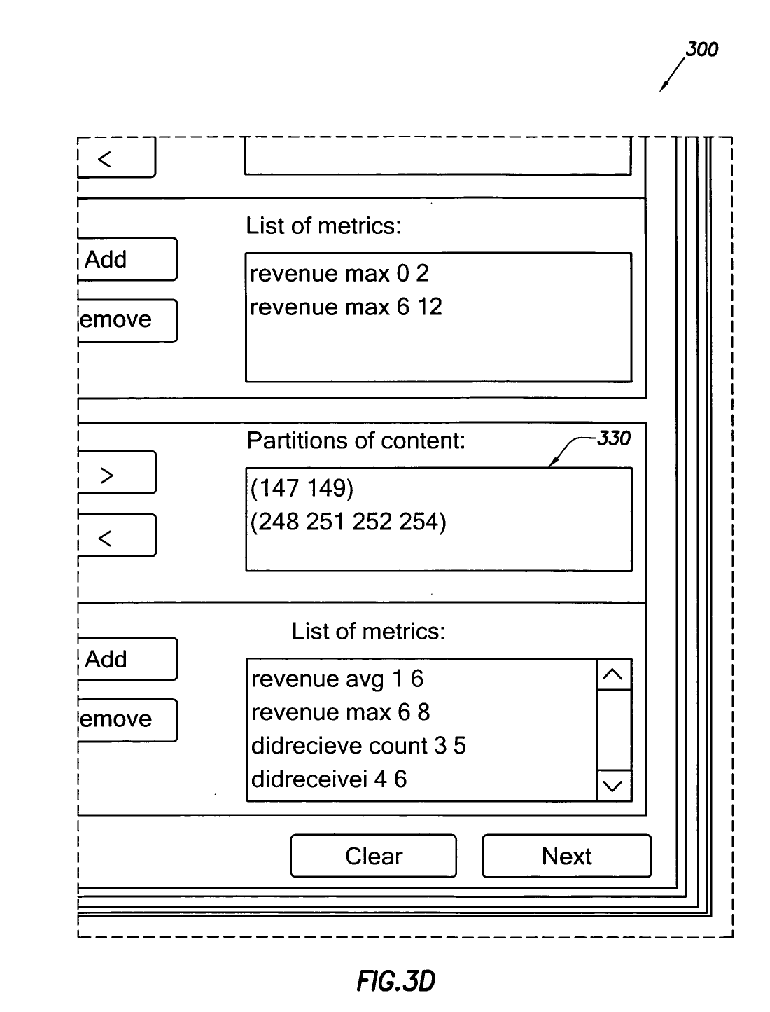

FIG. 3 provides an example of a GUI 300 that is usable to perform attribute extraction from data stored in database 102 in accordance with embodiments of the invention. The GUI can be different from that shown in FIG. 3. GUI 300 is shown by computer 104 on display 108. A user interacts with GUI 300 via an input device (e.g., keyboard 106). As illustrated in FIG. 3, GUI 300 presents an input interface to generate training datasets that can be used to develop a customer behavior model. Selection field 302 permits a user to select one or more static attributes 202 to use to filter data from the database 102. For example, the user may be interested in all customers who live in the United States. Accordingly, the “country” attribute can be selected (e.g., highlighted) in field 302 and will be shown in field 304. A user can select more than one static attribute depending on the desired level of filtering or customer targeting.

A user also selects a “class of contents” from selection field 305. The term “class of contents” means content elements or marketing stimuli, for example, promotional advertisements and/or discount coupons, that can be used as a further filter to the items found in database 102. The content elements help identify past offers and transactions that have been made that are relevant for learning a customer behavior model that can be used to predict the potential success or failure of a potential future customer offer that is currently being considered. The content elements selected can be grouped into sets as shown in selected item field 306. However, content elements in one embodiment do not repeat into multiple sets. Although, in selection field 305 ContentIDs are shown, the specific content could be listed in their place or in combination with the ContentIDs. A pop-up graphic could also be shown anytime the cursor is placed over any one ContentID providing further information on the particular ContentID (e.g., ContentID 6 could refer to a color printer advertisement for a specific product). A date range 307 is selected for the class of content. The selected data range can be selected, for example, based on a relevant time frame.

Stimulus Response Metrics (SRM) are also selected in GUI 300 by way of selection field 308. SRMs are part of a set of metrics that will be used in the prediction and can help specify the response metrics the user wants to predict. An illustrative example of a selectable SRM is revenue, as shown. Another example of an SRM includes the probability that a customer may accept a future marketing offer (e.g., use a discount coupon to purchase a printer). An SRM can be a cross between a set of stimuli and a response attribute (e.g., profit, revenue, number of items ordered) An SRM can also be an indicator, such as whether revenue (or profit or number of items ordered) exceeded a predetermined threshold. A second data structure allows for the linking of an aggregation function and a number that will be used for comparison purposes (e.g., <50) with the selected SRMs. The aggregation functions that can be selected include minimum (min), maximum (max), average, and sum. A transformation operator such as greater than (>), less than (<), greater than or equal to (≧) or less than or equal to (≦) can be also be included. A numeric number that can be used by the transformation operator to compare to, can be selected or entered. For example, if the greater than (>) aggregate operator is selected, the user can then enter a numeric value in field 313 such as “50” to generate the operator “greater than 50.” An “advanced” button (not shown) can also be used to show a “pop-up” window in which the user can select a different cost of misclassification values for each SRM if desired. These parameters are used by model fitting algorithms, such as CART.

GUI selection field 320 is used for the selection of Past Purchase Metrics (PPMs). PPMs include attributes derived from the purchase history of customers such as products purchased which are selected from field 320. The products can be labeled using their product name and/or by using a product SKU (stock keeping unit) number. The PPM is broken into specific products selected from field 320, a metric such as revenue selected from field 322, an aggregation function selected from selection field 324, and a time interval or range for the product that was purchased selected in field 326. An illustrative example of a time interval can be from for example 1 to 6 months from the current date. This selection would look for customers who purchased the selected product or products a month to six months ago.

GUI 300 also provides for the selection of Past Stimulus Metrics (PSMs). PSMs specify specific items from database 102 that are stimuli-based user actions stored in database 102 according to the set of content selected in field 306. PSMs are selected from field 328 and the selected partitions of content are highlighted in selected field 330. The user can input an aggregation function for the PSM. The available aggregation functions include minimum (min), maximum (max), average and sum. Along with the selected aggregation function the user can select a relevant time interval in 336 which refers to a range of the number of previous months based on the particular transaction reference date.

Once all of the information is entered via GUI 300, the attributes are extracted from database 102. The extracted attributes can then be used to generate a customer behavior model using response learning and prediction tools or the like.

Referring now to FIG. 4, there is shown a flowchart highlighting how customer attributes are extracted from transaction records that may reside for example in a database 102. In 402, a user provides information into the computer system 100, for example, using GUI 300. Although entry fields for some of the following may not be specifically shown in FIG. 3, illustrative inputs include customer identification information (CustomerID), reference date information, a set of customer attributes (SCA) that may exist in the database, set of product IDs (SPID) if available which identify particular products, and sets of content IDs (SCID). For each SPID and SCID, further information such as a set of metrics to be used in attributes are entered. These metrics can include, as described above, a set of Stimuli Reaction Metrics (SRMs) for measuring a customer's response to specific marketing stimuli, Past Purchase Metrics (PPMs) for attributes derived from the purchase history of customers, or Past Stimuli Metrics (PSMs) for attributes derived from past mailings or other marketing campaigns as examples.

At 404, customer attributes are extracted based on the customer ID and reference date information that was provided. In 406, the routine outputs, for example, in a single row, the CustomerID and for each customer attribute in the SCA, the customer attribute, as well as SPID and SCID information. The output is presented in some embodiments in an attribute table format associated with each customer ID.

An illustrative example of a customer attribute extraction is now presented. It may be desired, for example, to construct a customer response model for a magazine advertisement page for a color printer, and the particular color printer advertisement may be similar to an advertisement run in the past with a Content ID (CID) of CID0. The attribute extraction would be achieved by the following actions.

The user inputs CID0 as the CID used for event selection. In addition, the user inputs a time interval, for example, 01/01/2003 to 12/31/2003, for which the dataset is to be extracted.

If there is interest in results for customers that meet certain criteria (e.g., location, recency of last transaction), such criteria are entered to filter the database 102 to a list of customers that meet that criteria.

A potential customer prediction model that the user may want to determine may be the probability a customer would purchase the color printer and revenue when the customer is exposed to a particular advertisement (CID0). The corresponding stimuli-response metrics that the user inputs is “didRespond,” providing an indicator variable whether the customer responded to the offer of CID0 and revenue, and the revenue for the transaction.

Using the GUI 300, the user would enter the desired static attributes such as gender and age of customer and whether the customer owned a dog.

In order to derive transaction based attributes, the user then selects past transactions that might be relevant to the prediction model the user is trying to develop. For example, past purchases that might contain information on the purchasing behavior regarding the color printer that is of interest might be those transactions involving digital cameras, scanners, and laptops. The user then selects one or more models of the products just mentioned using the GUI 300 in selection field 320. The user may select three laptop computer models (lap1, lap2 and lap3), two specific scanner models (scan1 and scan2) and four digital cameras (cam1, cam2, cam3 and cam4). As previously discussed, the user under the PPM category can also select metrics using selection field 322, an aggregate function using selection field 324 and time intervals using selection field 326. In this particular illustrative example, for all the above products (also referred to as Set of Product IDs, SPIDs) selected above, the user selects revenue and profit using field 322, and three time intervals (also referred to as “recency intervals”) last six months, six months before that, and a year before that using field 326. The user also selects the sum of revenue and the sum of profit aggregate functions in field 324.

The user than selects stimulus-based attributes that might influence the customer's behavior. The stimuli, for example, might be three past advertisements about printers (SCID). The SCID in this example comprises SCID=(SCID Printers {PrinterAd1, PrinterAd2, PrinterAd3}). The user then selects time intervals using selection field 336, for example, the last six months, six months before that, and one year before that, as the time intervals of interest for the PSMs. For the PSMs selected, in this example, the user uses selection field 332 to select “customer received ad,” “customer purchased product,” revenue and profit. For the aggregation functions in selection field 334, the user selects maximum of “customer received ad,” maximum of customer purchased product,” average of revenue and average of profits.

The above entries will result in the following columns being extracted from database 102 for each customer in this illustrative example; each event meeting the specified criteria will create a row in a table with these column headers:

Gender|Age|OwnsDog|DigitalCamera.last6months.bought|
DigitalCamera.last6months.revenue|DigitalCamera.last6months.Profit|
DigitalCamera.6-12monthsAgo.bought|
DigitalCamera.6-12monthsAgo.revenue|
DigitalCamera.6-12monthsAgo.Profit|
DigitalCamera.moreThan12monthsAgo.bought|
DigitalCamera.moreThan12monthsAgo.revenue|
DigitalCamera.moreThan12monthsAgo.Profit|Scanner.last6months.bought|
Scanner.last6months.revenue| Scanner.last6months.Profit |
Scanner.6-12monthsAgo.bought | Scanner.6-12monthsAgo.revenue |
Scanner.6-12monthsAgo.Profit|Scanner.moreThan12monthsAgo.bought|
Scanner.moreThan12monthsAgo.revenue|
Scanner.moreThan12monthsAgo.Profit|Laptop.last6months.bought|
Laptop.last6months.revenue|Laptop.last6months.Profit|Laptop.6-12
monthsAgo.bought | Laptop.6-12monthsAgo.revenue |
Laptop.6-12monthsAgo.Profit|Laptop.moreThan12monthsAgo.bought|
Laptop.moreThan12monthsAgo.revenue |
Laptop.moreThan12monthsAgo.Profit |
PrinterAd.last6months.received|PrinterAd.last6months.responded|
PrinterAd.last6months.revenue | PrinterAd.last6months.Profit |
PrinterAd.6-12monthsAgo.received |
PrinterAd.6-12monthsAgo.responded |
PrinterAd.6-12monthsAgo.revenue|PrinterAd.6-12monthsAgo.Profit|
PrinterAd.moreThan12monthsAgo.received|
PrinterAd.moreThan12monthsAgo.responded|
PrinterAd.moreThan12monthsAgo.revenue|
PrinterAd.moreThan12monthsAgo.Profit|
CID0.didreceive|CID0.revenue

Once collected for each of the events, the above dataset can be used as a training dataset for a model calibration and subsequent customer behavior model development which are not addressed as part of the present invention. For each event and for each customer partaking in the event, a vector of attributes is generated and will be part of the training dataset that will be used to generate the customer behavior model. Each of the customers in the set will have their own information unique to them. In addition, a customer's transaction-based attributes will pertain to the customer at the time of the event that generated the row of information. For example, one customer may be a 43 year old male, with no dog, and that bought a digital camera in the last 6 months, along with other specifics about any of the other information noted above. Some customers from database 102 may not be included in the extracted dataset because they do not satisfy the user-specified criteria.

As described above, attributes have been extracted with respect to an event (which has a data) to create a training dataset for response model learning. If the response model is to be applied later to predict a response for a specific customer at a specific date, the above mechanism can be used to extract customer attributes by replacing the event date with a reference date that is input by the user.

Attributes are relative to either a given date or a specific transaction (e.g., printer purchase). Transactions that occur at different times are “aggregated” or “synchronized” to group them into attributes that are comparable between different customers. To aggregate events, the interaction-based attributes are expressed based on relative time intervals with respect to either a reference date or the date from which the event in which the record appears is derived.

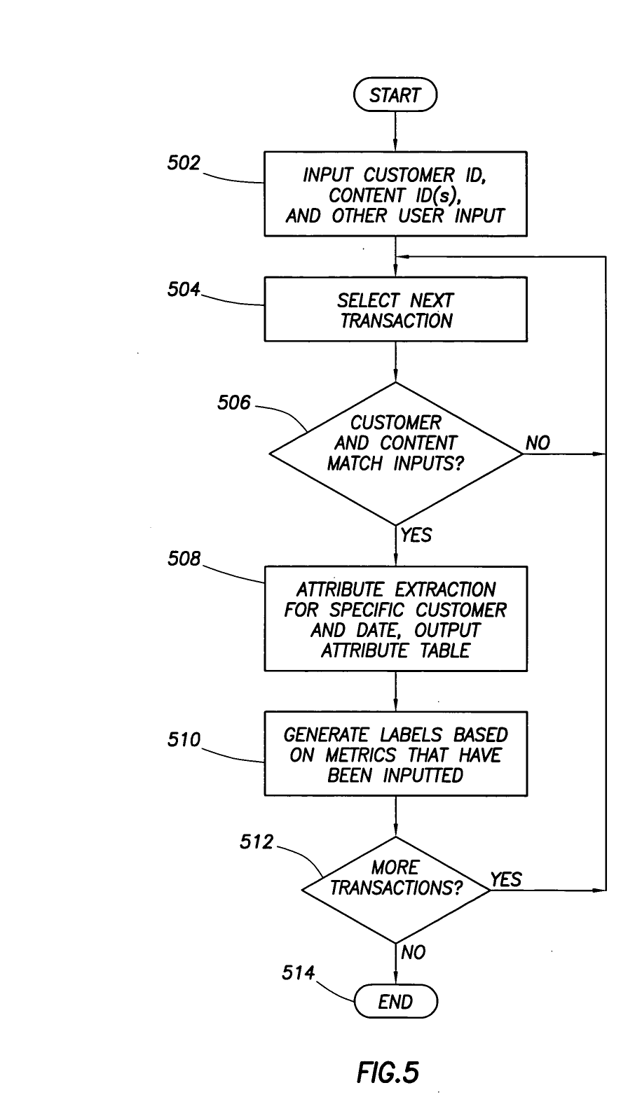

Referring now to FIG. 5, there is shown a flowchart highlighting how to perform a labeled dataset extraction in accordance with an embodiment of the invention. In 502, information provided by a user into the system can include the start and end date time window that will be analyzed, CustomerID information for one or more customers and a set of contentIDs (SCIDs), set of labeling of metrics that may be used for labeling and other information that will help in the extraction of the transactional data. The start and end dates provides a window for data that can be considered relevant for learning a particular behavior model of the customer.

The SCIDs provide a filtering effect and help identify past offers and transactions that are relevant for learning a behavior model that will be used to predict performance of a potential offer. SCIDs can include content elements that are assumed by a user to be similar to an element (e.g., marketing promotion) that is being considered for offering to the customer, as such, they can provide a good indication of potential customer behavior given the similarities between the content elements and the potential for high correlation in the customer's behavior.

In 504, the routine updates the current transaction being worked on and then in decision block 506, it is determined if a particular stored transaction refers to content in the SCIDs and if the particular customer is in the set of CustomerIDs. If it is determined that the transaction refers to content not in the SCIDs or that the particular customer is not in the set of CustomerIDs, the routine loops back to 504. If, however, it is found in 506 that the transaction refers to content in the SCID and that the customer is in the set of CustomerIDs, the routine moves to 508 where the attribute extraction is performed for the specific CustomerID and date. In this particular embodiment, the output comprises a row of information that includes the particular CustomerID, customer attributes if any are found in the SCA, and for each SPID and SCID any metrics and values of the metric that may be part of the specified time frames entered.

In 510, labels are generated based on the metrics specified during the input in 502 and are associated with the customer attribute information. In decision step 512, it is determined whether there are more transactions in the database to be reviewed based on the information provided in step 502. If there are more transactions to be reviewed, the routine lops back to 504. If there are no more transactions to be reviewed, the routine ends at 514.

The attribute extraction described above allows for a user to extract attributes for a training dataset using a simple to use approach. In one embodiment, the use of GUI 300 simplifies the entry of information thus avoiding the need for the use of a skilled database person to conduct the database query. The ease of use further allows for relevant attributes to be extracted which help describe the “state” of customers which results in improved customer response models being generated.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method for extracting customer attributes from a database, comprising:
providing information regarding content, a metric, customer identifier (ID) and a reference date; and
extracting customer attributes based on said information.

2. A method as defined in claim 1, wherein the customer attributes that are extracted are used to form a customer behavior model.

3. The method as defined in claim 2 further comprising using the customer behavior model to generate an advertisement, said advertisement comprising one selected from a group consisting of direct mail, web advertisement, and telephone solicitation.

4. A method as defined in claim 1, wherein the content comprises past offers or transactions that have been made to particular customers.

5. A method as defined in claim 1, wherein providing comprises providing a past purchase metric and past stimulus metrics.

6. A method as defined in claim 5, wherein providing information further comprises providing a stimulus response metric.

7. A method as defined in claim 5, wherein the past purchase metric comprises at least one from a group consisting of a stock keeping unit (SKU) and a value of interest.

8. A method as defined in claim 1, wherein the extracted attributes are extracted as a customer attribute table for each of a plurality of customer IDs.

9. A method as defined in claim 1 wherein extracting customer attributes comprises aggregating past customer transactions into said customer attributes grouped according to type of event, time interval and a metric to be aggregated.

10. A method as defined in claim 9, wherein the metric to be aggregated is selected from a group consisting of a stimulus response metric, a past purchase metric and a past stimulus metric.

11. A method as defined in claim 10, wherein the stimulus response metric is selected from a group consisting of revenue, profit, number of items ordered, number of categories ordered and an indicator.

12. A method as defined in claim 10, wherein the past purchase metric comprises transactions that are derived from past purchases made by customers.

13. A method as defined in claim 10, wherein the past stimulus metric comprises past marketing stimuli that have been presented to customers.

14. A method as defined in claim 10 wherein providing information also comprises providing content identification (ContentID) information and wherein extracting customer attributes comprises extracting customer attributes based also on the ContentID information, and the method further comprising generating a labeled dataset using the extracted customer attributes.

15. A method as defined in claim 14, further comprising using the labeled dataset as training data for a customer behavior model.

16. A method for extracting training datasets for customer behavior modeling from a database, comprising:
providing information describing an event, response metrics and a customer identifier (ID);
extracting customer attributes based on data associated with the event; and
labeling the extracted customer attributes based on the information.

17. A method as defined in claim 16 wherein extracting customer attributes is also based on a date.

18. A method as defined in claim 16, wherein the response metric(s) are selected from a group consisting of an indicator variable indicating whether the customer responded, a revenue of a transaction and a stated satisfaction of the customer with the product.

19. A method as defined in claim 16, wherein the event comprises a marketing stimulus.

20. A system, comprising:
means for providing information regarding one or more content, one or more metrics, customer ID and a reference date; and
means for extracting customer attributes based on said information.

21. A storage medium accessible to a computer, said storage medium containing software that, when executed by the computer, causes the computer to:
receive information regarding one or more content, one or more metrics, customer ID and a reference date; and
extract customer attributes based on said information.

22. The storage medium of claim 21 wherein the software further causes the computer form a customer behavior model using the extracted customer attributes.

23. The storage medium of claim 21 wherein the software further causes the processor to aggregate past customer transactions into said customer attributes grouped according to type of event, time interval and a metric to be aggregated

24. The storage medium of claim 21 wherein the software further causes the processor to generate a labeled dataset using the extracted customer attributes.

25. A method for extracting customer attributes from a database, comprising:
providing information regarding past transactions, a past purchase metric, a past stimulus metric, a stimulus response metric, customer identifier (ID) and a reference date;
extracting customer attributes based on said information, wherein extracting customer attributes comprises aggregating said past transactions into said customer attributes grouped according to type of event, time interval and a metric to be aggregated; and
forming a customer behavior model using the extracted customer attributes.
